(19) United States
(12) Patent Application Publication
(10) Pub. No.: US 2008/0160979 A1
(43) Pub. Date: Jul. 3, 2008

(54) Apparatus, Method, And Computer Program Product For Controlling Output Volume

(75) Inventor: Kun Huang, Kobenhavn (SV)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/618,305

(22) Filed: Dec. 29, 2006

(51) Int. Cl. H04M 1/247; H04M 1/00

(52) U.S. Cl. 455/418; 455/550.1

(57) ABSTRACT

A mobile terminal is provided that includes a communications unit configured to receive data via a wireless link. The mobile terminal also includes an audio output unit configured to receive audio data and output the audio data as sound having an output volume. A processor in communication with the communications unit is configured to direct audio data to the audio output unit. The processor controls the output volume of the audio output unit so as to automatically change the output volume from an initial output volume. A method and a computer program product are also provided.

### FIELD OF THE INVENTION

Embodiments of the present invention relate generally to apparatuses, methods, and computer program products for controlling output volume of audio data, and, more particularly, to apparatuses, methods, and computer program products for controlling output volume of audio data outputted by a mobile terminal.

### BACKGROUND OF THE INVENTION

Mobile terminals, such as mobile data devices, mobile communications devices, cellular telephones, and the like, are being increasingly used as music players. In this regard, many users download or otherwise store various electronic music files on their mobile terminals for subsequent consumption.

Along these lines, some users prefer to listen to music while falling asleep, and use a mobile terminal to play music while entering a state of slumber. However, once a user is fully asleep, it may be desirable to change the volume or stop the playing of music, as the continuing music may act to prematurely wake the user. Further, continued play at full volume may act to dissipate the energy supply of the mobile terminal to an unacceptable extent. Moreover, the use of a mobile terminal to play music may, at some point actually work against the user's objective of going to sleep since a user may have difficulty going to sleep while knowing that they should eventually wake up enough to turn off the mobile terminal.

### BRIEF SUMMARY OF THE INVENTION

In light of the foregoing background, exemplary embodiments of the present invention provide improved apparatuses, methods, and computer program products for controlling data output from a mobile terminal by automatically modifying an output volume for audio data. In cases where the desired output volume level for audio data varies over time, such automatic volume modification may allow audio data to be outputted continuously at desired levels without requiring continuing intervention.

According to one aspect of the present invention, a mobile terminal is provided. The mobile terminal includes a communications unit configured to receive data via a wireless link. The mobile terminal also includes an audio output unit configured to receive audio data and output the audio data as sound having an output volume. A processor in communication with the communications unit is configured to direct audio data to the audio output unit. The processor controls the output volume of the audio output unit so as to automatically change the output volume from an initial output volume. For example, the processor may be configured to reduce the output volume of the audio output unit, perhaps linearly over time. The mobile terminal may also include a memory in communication with the processor and configured to store audio data and, in some cases, instructions executable by the processor when controlling the output volume of the audio output unit. Some embodiments may include a user input device in communication with the processor, from which settings (e.g., a user-specified volume reduction rate or a time over which volume should reduce to zero) may be entered for subsequent use by the processor.

In some embodiments, the processor may control the output volume of the audio output unit so that the output volume reduces from an initial output volume to zero or some other predefined level. The processor may be further configured to modify a mode of operation of the mobile terminal subsequent to the output volume reaching the predefined level. For example, the processor may be configured to deactivate the audio output unit or the mobile terminal once the output volume reaches the predefined level.

According to another aspect of the present invention, a method for generating an output is provided. The method includes providing a mobile terminal having access to audio data. The audio data is outputted as sound from the mobile terminal, the sound having an output volume. The output volume of the sound is then automatically decreased from an initial output volume.

According to yet another aspect of the present invention, a computer program product is provided. The computer program product includes a computer-readable storage medium having computer-readable program code portions stored therein. The computer-readable program code portions are executable by a mobile terminal having access to audio data and include a first executable code portion for outputting the audio data as sound from the mobile terminal, the sound having an output volume. Also included is a second executable code portion for automatically decreasing the output volume of the sound from an initial output volume.

According to still another aspect of the present invention, an apparatus is provided. The apparatus includes means for receiving data via a wireless link and means for receiving audio data and outputting the audio data as sound having an output volume. Means are further provided for directing the audio data to the data receiving and outputting means. The directing means is further configured to control the output volume of the data receiving and outputting means so as to automatically change the output volume from an initial output volume.

According to yet another aspect of the present invention, an apparatus is provided, the apparatus having a processor. The processor is in communication with a communications unit for receiving data over a wireless link, as well as an audio output unit. The processor is configured to direct audio data to the output unit and to control the output volume of the audio output unit so as to automatically change the output volume from an initial output volume.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic perspective view of a mobile terminal configured in accordance with an exemplary embodiment;

FIG. 2 is a block diagram of the mobile terminal of FIG. 1, showing various operational units of the mobile terminal; and

FIG. 3 is a flow chart illustrating a method for using a mobile terminal configured in accordance with exemplary embodiments.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

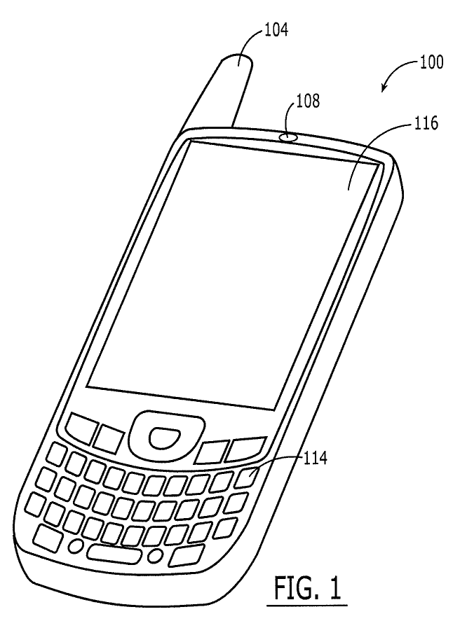

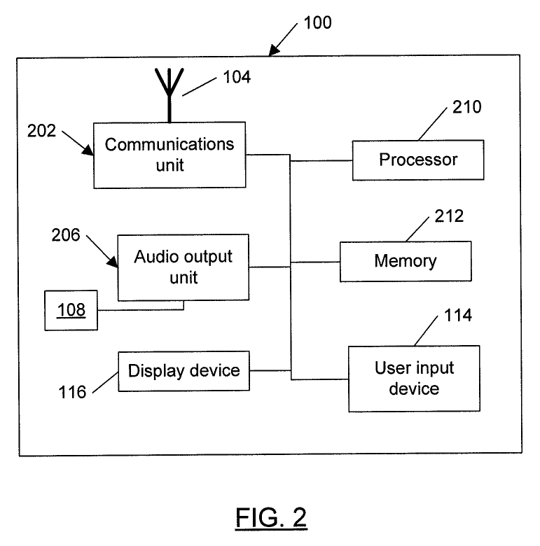

Referring to FIGS. 1 and 2, therein is shown a mobile terminal 100 configured in accordance with an exemplary embodiment. It should be understood, however, that a mobile data device as illustrated and hereinafter described is merely illustrative of one type of mobile terminal that would benefit from embodiments of the present invention and, therefore, should not be taken to limit the scope of embodiments of the present invention. While one embodiment of the mobile terminal 100 is illustrated and will be hereinafter described for purposes of example, other types of mobile terminals, such as portable digital assistants (PDAs), cellular telephones, pagers, mobile computers, mobile televisions, gaming devices, laptop computers, cameras, video recorders, global positioning system (GPS) devices, and other types of voice and text communications systems, can readily employ embodiments of the present invention. Furthermore, devices that are not mobile may also readily employ embodiments of the present invention.

Mobile terminal 100 may include means, such as a communications unit 202, typically including a receiver and/or transmitter, configured to transmit and receive data via a wireless link, for example, via an antenna 104, and/or from a physical network. Mobile terminal 100 may also include means, such as an audio output unit 206, configured to receive audio data and output the audio data as sound having an output volume. In one embodiment, audio output unit 206 may include a speaker 108 or similar sound output device.

Means, such as a processor 210, may be provided in communication with communications unit 202 and, in some cases, with a memory 212, for controlling the output of the audio data. Processor 210 may be configured to direct audio data, such as data representing a musical performance, to output unit 206. Such audio data may come from memory 212, may be received via communications unit 202 (and possibly stored in memory 212), and/or from some other media that is coupled either temporarily or permanently with mobile terminal (e.g., a compact disk or other memory/storage device). Processor 210 may be further configured to control the output volume of audio output unit 206 so as to automatically change the output volume from an initial output volume.

The manner in which processor 210 controls the volume change is not limited, and can be any function of, or have any relation to, time that is desired. For example, processor 210 may cause the output volume to be reduced linearly over time. This reduction could be accomplished, for example, by specifying a volume reduction rate or a time over which volume might be reduced to zero, the rate or time being received by processor 210. Alternatively, volume reduction may follow some non-linear function to allow, for example, a volume change that is initially small in rate but increasing over time. In some embodiments, volume may not have a continuous relationship with time, but may instead consist of a series of volume steps. Whatever manner of volume change is utilized, the volume change may begin immediately after the commencement of audio output, or may begin after a period of delay.

In some embodiments, processor 210 may cause the output volume to reduce to a predefined or predetermined level, such as zero. Processor 210 may be configured to modify a mode of operation of mobile terminal 100 as the output volume approaches or reaches the predefined level. For example, processor 210 may reduce the output volume to the predefined level and then deactivate, e.g., turn off, audio output unit 206. Alternatively, processor 210 may cause the mobile terminal 100 to deactivate when the output volume reaches the predefined level. In still another alternative, processor 210 may cause mobile terminal 100 to enter a mode of limited functionality or “sleep mode” when volume reaches the predefined level. In such a sleep mode, the mobile terminal may retain the ability to alert a user to the reception of data (such as an incoming telephone call) but might otherwise operate so as to reduce power consumption, for example, by ceasing the play of music. In yet other alternatives, processor 210 may deactivate a display device 116 of mobile terminal or terminate an application (e.g., a software application) when volume reaches the predefined level.

In some embodiments, mobile terminal 100 may include a user input device 114, such as a keyboard or keypad, mouse, trackball, stylus, etc., in communication with processor 210. User input device 114 may be used for, amongst other things, adjusting various settings of mobile terminal related to volume control and associated operations. For example, user input device 114 may be used to specify a reduction rate according to which processor 210 may cause the output volume to be reduced, or a time over which output volume will reduce to the predefined level (which predefined level may also be user specified). User input device 114 may be used to specify any action that should be taken by processor 210 when volume is reduced to zero or some minimum value, such as turning off mobile terminal 100, putting the mobile terminal 100 into a sleep mode, etc. Memory 212 may store instructions executable by processor 210 (i.e., software) for receiving such user defined settings. Once entered, memory 212 may store any inputted settings for subsequent use and/or modification. The software stored in memory 212 may also cause processor 210, when executing the instructions, to perform the above described volume control functions. Volume control may additionally be determined by the hardware and/or software of the mobile terminal 100.

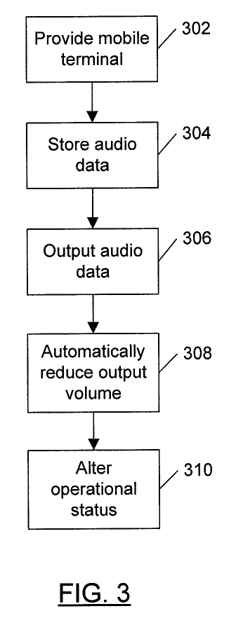

An exemplary use for the above described mobile terminal is now provided in conjunction with FIG. 3. At Block 302, a mobile terminal is provided, the mobile terminal having access to audio data. For example, audio data such in the form of songs may be stored in a memory of the mobile terminal. Alternatively, mobile terminal may include an antenna and be capable of accessing streaming and/or broadcast content. At Block 304, audio data may be stored at the mobile terminal, for example, in a memory of the mobile terminal. At Block 306, the audio data may be outputted as sound from the mobile terminal, the sound having an output volume. For example, where the audio data includes one or more songs, a user of the mobile terminal may specify, using a user input device of the mobile terminal, a song to be outputted and an initial output volume for the music.

At Block 308, the output volume of the music may be automatically decreased from an initial output volume, possibly controlled by a processor of the mobile terminal. At Block 310, output volume reaches zero (or some other minimum value), at which point the processor of the mobile terminal may alter the operational status of the mobile terminal. For example, the processor may cause the mobile terminal to power off when the volume reaches zero.

Much of the previous discussion has focused on a mobile terminal in which a processor affects a reduction in output volume over time, possibly followed by a powering off of the mobile terminal. However, in some embodiments, a mobile terminal is configured such that a processor causes an output volume to increase over time, possibly from zero volume to some maximum volume. This increase could be preceded by a powering on of the mobile terminal, or of an audio output device thereof. In one embodiment, the mobile terminal could be configured to power on and/or increase volume at a certain time (which would also be kept by the mobile terminal) so as to act as an alarm.

As described above and as will be appreciated by one skilled in the art, embodiments of the present invention may be configured as a system, an apparatus, or a method. Accordingly, embodiments of the present invention may be comprised of various means including entirely of hardware, entirely of software, or any combination of hardware and software. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mobile terminal comprising:
a communications unit configured to transmit and receive data via a wireless link;
an audio output unit configured to receive audio data and output the audio data as sound having an output volume; and
a processor in communication with said communications unit and configured to direct audio data to said audio output unit and to control the output volume of said audio output unit so as to automatically change the output volume from an initial output volume.

2. A mobile terminal according to claim 1, further comprising a memory in communication with said processor and configured to store audio data.

3. A mobile terminal according to claim 2, wherein said memory is further configured to store instructions executable by said processor, said processor controlling the output volume of said audio output unit based on the executed instructions.

4. A mobile terminal according to claim 1, wherein said processor is configured to control the output volume of the audio output unit, such that the output volume is reduced from the initial output volume.

5. A mobile terminal according to claim 4, wherein said processor is configured to control the output volume of the audio output unit, such that the output volume is reduced linearly over time from the initial output volume.

6. A mobile terminal according to claim 4, further comprising a user input device in communication with said processor, and wherein said processor is configured to receive a user-specified reduction rate from said user input device and to cause the output volume of the audio output device to reduce at the user-specified reduction rate.

7. A mobile terminal according to claim 6, wherein said processor is configured to receive from said user input device a time over which the output volume is to decrease from an initial output volume to a predefined level.

8. A mobile terminal according to claim 4, wherein said processor is configured to control the output volume of said audio output unit, such that the output volume reduces from an initial output volume to a predefined level, and said processor is also configured to modify a mode of operation of said mobile terminal subsequent to the output volume reaching the predefined level.

9. A mobile terminal according to claim 8, wherein said processor is configured to deactivate said mobile terminal once the output volume reaches the predefined level.

10. A mobile terminal according to claim 8, wherein said processor is configured to deactivate said audio output unit once the output volume reaches the predefined level.

11. A method for generating an output, said method comprising:
providing a mobile terminal configured to transmit and receive data and also having access to audio data;
outputting the audio data as sound from the mobile terminal, the sound having an output volume; and
automatically changing the output volume of the sound from an initial output volume.

12. A method according to claim 11, further comprising storing audio data at the mobile terminal.

13. A method according to claim 11, wherein automatically changing the output volume of the sound from the initial output volume includes automatically decreasing the output volume from the initial output volume to a predefined level.

14. A method according to claim 13, further comprising deactivating the mobile terminal subsequent to the output volume reaching the predefined level.

15. A method according to claim 13, further comprising deactivating an output unit of the mobile terminal subsequent to the output volume reaching the predefined level.

16. A method according to claim 13, wherein automatically decreasing the output volume of the sound from the initial output volume to a predefined level includes automatically decreasing the output volume linearly over time from the initial output volume to the predefined level.

17. A method according to claim 16, further comprising receiving at the mobile terminal a user-specified time over which the output volume is to decrease from an initial output volume to the predefined level, and wherein automatically decreasing the output volume linearly over time from an initial output volume to the predefined level includes automatically decreasing the output volume linearly over the user specified time from an initial output volume to the predefined level.

18. A computer program product comprising a computer-readable storage medium having computer-readable program code portions stored therein, the computer-readable program code portions being executable by a mobile terminal configured to transmit and receive data via a wireless link and having access to audio data, the computer-readable program code portions comprising:
a first executable code portion configured to output the audio data as sound from the mobile terminal, the sound having an output volume; and
a second executable code portion configured to automatically change the output volume of the sound from an initial output volume.

19. An apparatus comprising:
means for transmitting and receiving data via a wireless link;
means for receiving audio data and outputting the audio data as sound having an output volume; and
means for directing the audio data to said data receiving and outputting means,
wherein said directing means is further configured to control the output volume of said data receiving and outputting means so as to automatically change the output volume from an initial output volume.

20. An apparatus comprising:
a processor in communication with a communications unit for transmitting and receiving data over a wireless link and an audio output unit, said processor being configured to direct audio data to the output unit and to control the output volume of the audio output unit so as to automatically change the output volume from an initial output volume.
